(19) United States
(12) Patent Application Publication
(10) Pub. No.: US 2009/0067968 A1
(43) Pub. Date: Mar. 12, 2009

(54) Lifting device

(76) Inventor: Arthur K. McVaugh, Green Lane, PA (US)

Correspondence Address: KINNEY & LANGE, P.A., THE KINNEY & LANGE BUILDING, 312 SOUTH THIRD STREET, MINNEAPOLIS, MN, 55415-1002, US

(21) Appl. No.: 11/899,699

(22) Filed: Sep. 7, 2007

(51) Int. Cl. B60P 1/54; H02K 7/18

(52) U.S. Cl. 414/550; 310/75 R

(57) ABSTRACT

A lifting device for attachment to a vehicle trailer hitch. A lifting boom extends over the centerline of the vehicle and is attached to a vertical arm that has a side arm extending to the hitch. A mechanical screw jack that functions as a linear actuator raises the lifting boom about a pivot point in the vertical direction and is driven by a rotating power means such as a cordless drill. The vertical arm also includes a swivel bearing that permits movement of the lifting boom over the sides of the vehicle.

### FIELD OF THE INVENTION

The present invention relates to a lifting device for use with a truck or other vehicle having a platform or bed for carrying objects. More particularly, the invention relates to a lifting device that is adapted to be removably attached to a vehicle trailer hitch or the like and which is capable of lifting loads under hydraulic or other power.

### BACKGROUND OF THE INVENTION

One of the most useful and popular vehicles today is the pickup truck, both for commercial and hobby activities. As part of the acceptance of pickups, not only for general transportation, hauling, top-cover carrying of tools and camping supplies, and pulling trailers and the like, is the desire for versatility. Of primary importance is the ability to use the bed of the pickup as a platform for hauling heavy objects.

Since pickup trucks have a load-rated hauling level much greater than one or two humans can quickly load into the bed, it has become desirable to be able to quickly and efficiently lift heavy objects into the pickup. Examples of loads are farm supplies such as animal feed, seeds and fertilizers, and the like. Hay bales are a common product carried by pickup trucks.

The prior art does not disclose a simple device supported on the centerline hitch of a vehicle to lift loads without resort to complicated, expensive or elaborate mechanisms. None of the prior art provides a simple device for insertion into an existing trailer hitch by one person working alone, whereby the device is capable of easily lifting and loading up to at least 800 pounds or more without assistance. Particularly, no prior device exists for lifting large loads within a space not much larger than the area taken by the vehicle itself other than a hydraulic device shown in my Lifting Device, U.S. Pat. No. 6,042,328, issued Mar. 28, 2000.

There is one device, shown in my U.S. Pat. No. 6,024,328, which can be attached to an existing trailer hitch and can lift objects on to a pickup truck bed. This device uses a hydraulic motor to generate the power needed to lift the arm in a vertical path to move objects from the ground to the truck bed or back. The problem with the hydraulic motor design is that it is expensive to manufacture, requires maintenance and additional safety features to prevent failure of the hydraulic cylinder during operation. The truck battery driven pump, lock valves, fluid flow controls and the rod fed hydraulic cylinder are all costly. Users who are not familiar with hydraulics experience maintenance difficulties. The other problem with this prior art design is that it is limited to lifting in a vertical path and thus can only load or unload off the back of the vehicle.

Accordingly, it is an object of the present invention to provide a lifting device for use with a pickup truck or other similar platform that allows objects to be loaded and unloaded to the back and over the sides of the vehicle.

Another object of this invention is to provide a lifting device that is easily attached to a vehicle, such as a pickup truck, by one individual of average strength, yet which device does not use hydraulic forces.

Other objects will appear hereinafter.

### SUMMARY OF THE INVENTION

It has now been discovered that the above and other objects of the present invention may be accomplished in the following manner. Specifically, the present invention provides a lifting device for attachment to a trailer hitch or the like on a pickup truck or other vehicle. The device can also be mounted on stationary platforms, since the movement of the truck or other vehicle doesn't form part of the invention.

The lifting device includes a lifting boom having one end over the hitch and a second end having a lifting arm centered over the cargo bed for lifting a load. The one end is attached to a vertical member that extends down to the general level of the hitch, where it mates with a side arm extending to the hitch.

The second end of the lifting boom is mounted to the vertical member and defining a pivot point, and the lifting boom pivots by a linear actuator through an arc to and from being centered over the cargo bed to a proximate the ground on which the vehicle sits. A stabilizing column forming a link between the linear actuator and the vertical member and supports the linear actuator during at least a portion of its movement of the lifting boom. A rotating power means such as a cordless electric drill drives the linear actuator to cause the movement through the arc.

In a preferred embodiment, the stabilizing column is a telescoping column adapted to extend as the lifting boom moves from the first position to the second position. Also preferred is a rotating support adapted to move the vertical member about the axis defined by the vertical member to permit the lifting boom to, swivel in a horizontal plane from over the cargo bed of the vehicle.

### BRIEF DESCRIPTION OF THE DRAWINGS

For a more complete understanding of the invention, reference is hereby made to the drawings, in which:

FIG. 1 is a side elevational view illustrating the present invention, in which the device is shown in solid lines positioned over the pickup truck bed and in dot/dash lines having rotated through the arc to engage or disengage an object on the ground;

FIG. 2 is a top plan view of a portion of the device shown in FIG. 1;

FIG. 3 is a rear view of a portion of the device shown in FIG. 1;

FIG. 4 is an enlarged view of a portion of the arm shown in FIG. 1.

FIG. 5 is a diagram illustrating the geometric relationships of critical elements in the present invention.

### DETAILED DESCRIPTION OF THE PREFERRED EMBODIMENT

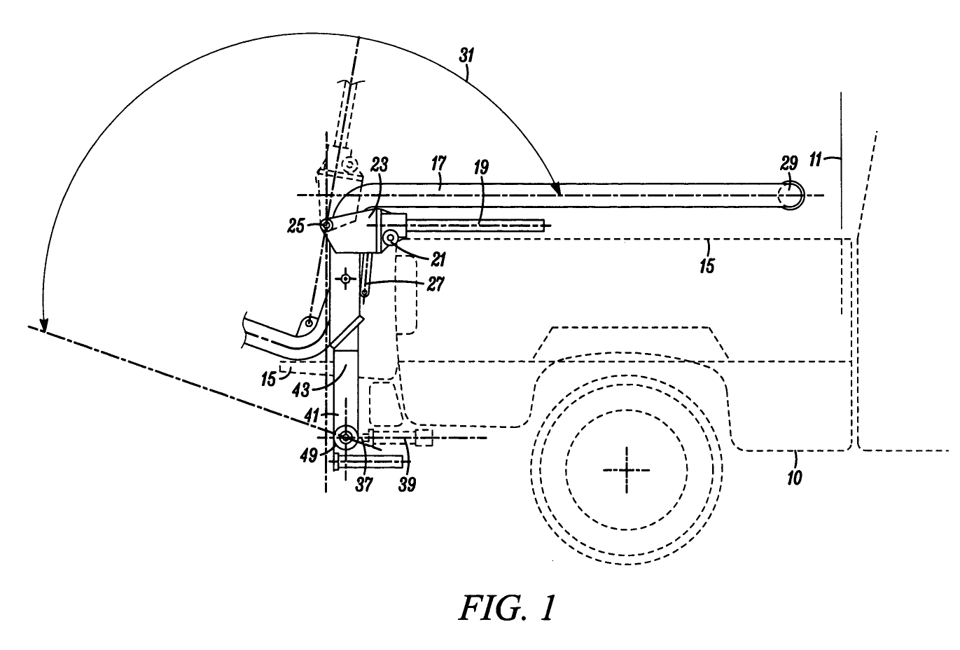

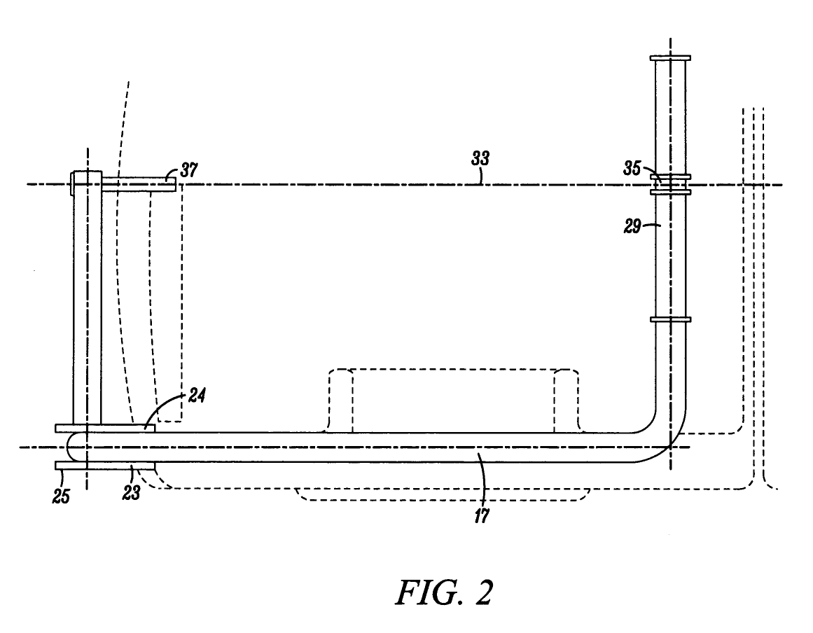

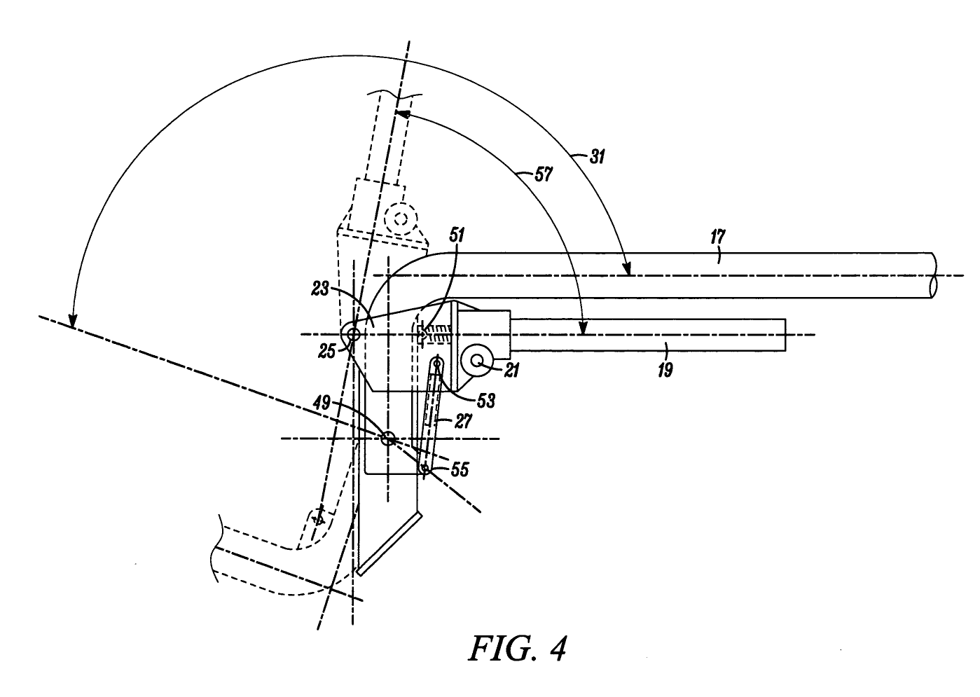

As shown in the drawings, the present invention is used with a vehicle 10, such as a pickup truck, with a cab 11 and sides 15. The device includes a lifting boom 17 that is preferably L-shaped at one end extending down on to vertical member 43 as seen in FIGS. 1 and 4. The other end of lifting boom 17 is attached to a lifting arm 29 that extends over to the truck bed center 33, as seen in FIG. 2. Lifting arm 29 may have a pulley 35 or other attachment for having a load attached to the lifting arm 29.

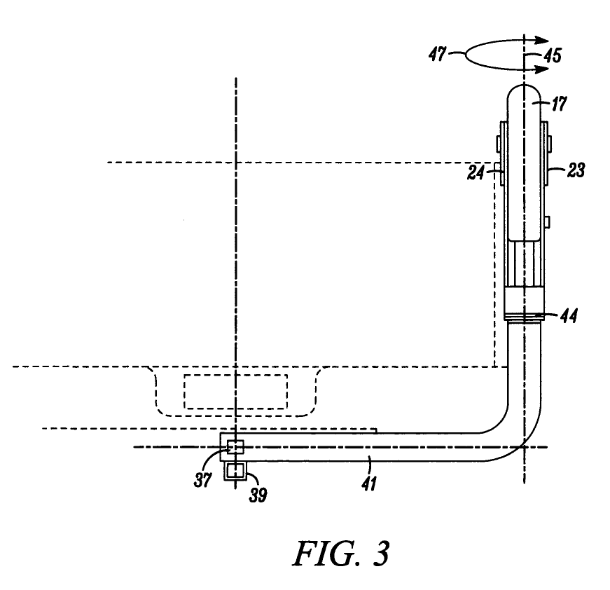

The vertical member 43 extends down to about level with the hitch 39 on truck 10 and is attached to a side arm 41 which engages hitch 39 with hitch engaging member 37, as best seen in FIG. 1. It may be desirable to include a second hitch 39a, as seen in FIG. 3, for towing other trailers and the like.

The lifting boom 17 moves through an arc illustrated in part by arrow 31 in FIG. 1, and pivots about bolt 49 or other pivot means. A pair of plates 23 and 24 form a yoke that mounts a linear actuator 19, which is a conventional screw jack in FIG. 1. Power by a rotating power means such as an electric drill is applied to fitting 21, such that rotation of the drill causes the linear actuator screw 51 to move from its position shown in FIG. 1 linearly toward and past pivot point 25. The power means may be an electric motor, cordless drill, hand crank, hydraulic motor or pneumatic motor, as desired.

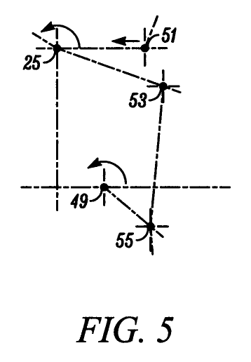

Stabilizing column 27 helps support linear actuator 19 in the first part of its movement, and the actuator 19 moves through arc 57 while the lifting boom 17 moves through arc 31 which extends 160 degrees and thus more than shown in FIG. 1. FIGS. 4 and 5 illustrate the geometry of the relative motions of the parts, as the lifting boom 17 pivots about pivot point 49 and stabilizing column 27, attached by bolts 53 and 55, supports the linear actuator 19 in the first part of its travel. Stabilizing column 27 is preferably a telescoping column that can extend out as far as necessary once lifting boom 17 has been moved up and over the tail gate of truck 10. Stabilizing column 27 moves about bolt 49.

FIG. 3 illustrates a preferred embodiment in which the end of lifting boom 17 mated with vertical member 43 can swing horizontally about the axis 45 of vertical member 43 as shown by arrow 47. Vertical member 43 includes a bearing means 44 that supports it and permits rotation so that lifting boom 17 can be rotated over the side 15 of the truck, adding an ability to reach or place objects on the side of the lifting device.

The lifting device of this invention is admirably suited for use with a pickup truck and has shown great versatility in, for example, various construction and farming applications as well as with hobbies and general hauling tasks. Typical loads include motorized vehicles such as motorcycles, four-wheelers, golf carts and the like, as well as building supplies, garden supplies, furniture, luggage and other objects normally carried by pickup trucks. The present invention permits loading and unloading of heavy objects weighing over 1,000 pounds or more. The lifting device may also be mounted on a fixed platform, such as a loading dock and can be used for maritime loading and unloading of boats and ships such as fishing boats or pleasure craft. Although shown mounted on the right side of vehicle when viewed from the rear, the lifting device may be modified to allow mounting on the opposite side of the vehicle when, for example, the vehicle is driven in countries that require vehicles to drive to the left side of roads. By mounting the lifting device on the proper side of the vehicle, loading and unloading of loads next to roads may be accomplished while avoiding any traffic in adjacent lanes of travel.

While particular embodiments of the present invention have been illustrated and described, it is not intended to limit the invention, except as defined by the following claims.

1. A lifting device for attachment to a vehicle having a cargo bed and a trailer hitch, comprising:
a lifting boom having one end over said hitch and a second end having a lifting arm centered over said cargo bed for lifting a load;
a vertical member attached at one end to the second end of said lifting boom and a second end extending down to the general level of said hitch;
a side arm attached to said second end of said vertical member and extending to a hitch engaging end, said hitch engaging end further including a hitch engaging member;
a pair of plates forming a yoke mounting said second. end of said lifting boom to said one end of said vertical member and defining a pivot point;
said plates further mounting a linear actuator for moving said lifting boom through an arc that moves said second end of said lifting boom to and from a first position centered over said cargo bed to a second position proximate the ground on which the vehicle sits;
a stabilizing column forming a link between said linear actuator and said lifting boom, said stabilizing column supporting said linear actuator during at least a portion of its movement of said lifting boom from said first position to said second position; and
rotating power means for turning said linear actuator to cause said movement through said arc.

2. The device of claim 1, wherein said lifting boom is L-shaped and engages said vertical member in the vertical direction.

3. The device of claim 1, wherein said arc of said lifting boom is about 160 degrees with respect to said cargo bed of said vehicle.

4. The device of claim 1, wherein said rotating power means is a drill.

5. The device of claim 4, wherein said drill is electrically powered.

6. The device of claim 5, wherein said drill is a cordless electrically powered drill.

7. The device of claim 1, wherein said stabilizing column is a telescoping column adapted to extend as said lifting boom moves from said first position to said second position.

8. The device of claim 1, which further includes a rotating support adapted to move said vertical member about the axis defined by said vertical member to permit said lifting boom to swivel in a horizontal plane from over said cargo bed of said vehicle.

9. A lifting device for attachment to a vehicle having a cargo bed and a trailer hitch, comprising:
lifting boom means for lifting a load and having one end over said hitch and a second end having a lifting arm centered over said cargo bed;
vertical member means for attachment at one end to the second end of said lifting boom means and a second end extending down to the general level of said hitch;
side arm means for engaging said hitch and attached to said second end of said vertical member means and extending to a hitch engaging end, said hitch engaging end further including a hitch engaging member;
a pair of plates forming a yoke mounting said second end of said lifting boom means to said one end of said vertical member means and defining a pivot point;
said plates further mounting a linear actuator means for moving said lifting boom means through an arc that moves said second end of said lifting boom means to and from a first position centered over said cargo bed to a second position proximate the ground on which the vehicle sits;
stabilizing column means for forming a link between said linear actuator means and said lifting boom means, said stabilizing column supporting said linear actuator during at least a portion of its movement of said lifting boom means from said first position to said second position; and
rotating power means for turning said linear actuator means to cause said movement through said arc.

10. The device of claim 9, wherein said lifting boom means is L-shaped and engages said vertical member means in the vertical direction.

11. The device of claim 9, wherein said arc of said lifting boom means is about 160 degrees with respect to said cargo bed of said vehicle.

12. The device of claim 9, wherein said rotating power means is a drill.

13. The device of claim 12, wherein said drill is electrically powered.

14. The device of claim 13, wherein said drill is a cordless electrically powered drill.

15. The device of claim 9, wherein said stabilizing column means is a telescoping column adapted to extend as said lifting boom means moves from said first position to said second position.

16. The device of claim 9, which further includes a rotating support means for moving said vertical member about the axis defined by said vertical member to permit said lifting boom to swivel in a horizontal plane from over said cargo bed of said vehicle.

17. A lifting device for attachment to a vehicle having a cargo bed and a trailer hitch, comprising:
a lifting boom having one end over said hitch and a second end having a lifting arm centered over said cargo bed for lifting a load;
a vertical member attached at one end to the second end of said lifting boom and a second end extending down to the general level of said hitch, said lifting boom being L-shaped and engages said vertical member in the vertical direction;
a side arm attached to said second end of said vertical member and extending to a hitch engaging end, said hitch engaging end further including a hitch engaging member;
a pair of plates forming a yoke mounting said second end of said lifting boom to said one end of said vertical member and defining a pivot point;
said plates further mounting a linear actuator for moving said lifting boom through an arc that moves said second end of said lifting boom to and from a first position centered over said cargo bed to a second position proximate the ground on which the vehicle sits, said arc being about 160 degrees with respect to said cargo bed of said vehicle;
a stabilizing column forming a link between said linear actuator and said lifting boom, said stabilizing column supporting said linear actuator during at least a portion of its movement of said lifting boom from said first position to said second position; and
an electrically powered rotating power means for turning said linear actuator to cause said movement through said arc.

18. The device of claim 17, wherein said electrically powered rotating power means is a cordless drill.

19. The device of claim 17, wherein said stabilizing column is a telescoping column adapted to extend as said lifting boom moves from said first position to said second position.

20. The device of claim 17, which further includes a rotating support adapted to move said vertical member about the axis defined by said vertical member to permit said lifting boom to swivel in a horizontal plane from over said cargo bed of said vehicle.
